(19) United States
(12) Patent Application Publication
(10) Pub. No.: US 2013/0290164 A1
(43) Pub. Date: Oct. 31, 2013

(54) Self-Operated Loan Originator

(71) Applicant: Nicholas J. Salm, Appleton, WI (US)

(72) Inventor: Nicholas J. Salm, Appleton, WI (US)

(21) Appl. No.: 13/459,510

(22) Filed: Apr. 30, 2012

(51) Int. Cl. G06Q 40/02

(52) U.S. Cl. 705/38; 705/35

(57) ABSTRACT

A self-operated loan originator (SOLO) apparatus is configured to generate at least one stacked loan application object. The apparatus includes at least one applicant interface which includes hardware and software for receiving applicant data to create at least one applicant data object. A SOLO server receives the at least one applicant data object and transforms the data from the applicant data object to create at least one lender vendor request object. The lender vendor request object is relayed to one of a plurality of lender vendor servers. The SOLO server also stores at least one data object which contains data specifying at least one stacked application order.

### CROSS-REFERENCE TO PRIORITY APPLICATIONS

This application claims priority to U.S. Provisional Application No. 61/469,187 filed on Mar. 30, 2011 and U.S. Nonprovisional application Ser. No. 13/436,227 filed on Mar. 30, 2012.

### FIELD OF INVENTION

The present invention relates to loan processing hardware, and more specifically to a distributed computer hardware apparatus and system utilizing a Self-Operated Loan Originator (SOLO) server hardware component that allows a person seeking a home loan to select a loan product and generate a complete, organized loan application for lenders and underwriters.

### BRIEF DESCRIPTION OF THE DRAWINGS

FIG. 1 illustrates an exemplary embodiment of a self-operated loan originator (SOLO) apparatus.

FIG. 2 illustrates a single exemplary communication loop between a SOLO server and a lender vendor server.

FIG. 3 is a flowchart illustrating a single exemplary communication loop between a SOLO server and a lender vendor server.

FIG. 4 is a flowchart illustrating an exemplary loan approval processing using a SOLO server.

### GLOSSARY

As used herein, the term “applicant” refers to a user of a mortgage application processor that is determined to be eligible for one or more loans and chooses to proceed with choosing a lender.

As used herein, the term “lender” means the approving authority and funding authority for a loan.

As used herein, the term “lender vendor” refers to third parties other than a lender which may be involved in the loan application process and may be used by a lender to obtain information about an applicant. Lender vendors may include, but are not limited to, credit companies, appraisal companies, title companies, insurance companies, lending institutions and under miters.

As used herein, the term “applicant data” refers to any information required or utilized by lenders prior to applying for or obtaining a loan. Applicant data may include, but is not limited to, employment status, current income, credit history, credit score data, payment records, collateral, tax documents, any other information which may affect an applicant's or user's ability to obtain a loan and combinations thereof. Applicant data may be dynamically changed by lenders and on a software interface may be reflected as a series of options or drop boxes requesting further delineation of criteria after an initial criterion is specified.

As used herein, the term “object” refers to a data structure which includes data attributes and/or functions.

As used herein, the term “underwriter” refers to the approving authority or review authority of a loan application.

As used herein, the terms “applicant interface,” “closing department interface,” “seller's interface” and “user interface” refer to any structure or device known in the art to allow a user to communicate with a SOLO server.

As used herein, the term “credit report request object” means a compilation of attributes and behaviors that encapsulates a credit request.

As used herein, the term “credit report object” means a compilation of attributes and behaviors that encapsulates a credit report.

As used herein, the term “prequalification request object” means a compilation of attributes and behaviors that encapsulates a prequalification request.

As used herein, the term “prequalification approval object” means a compilation of attributes and behaviors that encapsulates a response to a prequalification request.

As used herein, the term “appraisal request object” means a compilation of attributes and behaviors that encapsulates an appraisal request.

As used herein, the term “appraisal report object” means a compilation of attributes and behaviors that encapsulates an appraisal report.

As used herein, the term “title commitment request object” means a compilation of attributes and behaviors that encapsulates a title commitment request.

As used herein, the term “title commitment object” means a compilation of attributes and behaviors that encapsulates a title commitment.

As used herein, the term “insurance request object” means a compilation of attributes and behaviors that encapsulates an insurance report request.

As used herein, the term “insurance report object” means a compilation of attributes and behaviors that encapsulates an insurance report.

As used herein, the term “application status object” means a compilation of attributes and behaviors that encapsulates a loan application status.

As used herein, the term “lender vendor server” refers to a computer processor configured with software and hardware for processing, recording and communicating lender vendor transactions.

### BACKGROUND

Obtaining a home loan involves compiling a significant amount of information about, including information about the applicant and the home being purchased or refinanced. It is also requires the applicant to understand and make informed decisions about the interest rate and terms of a loan in the face of a variety of mortgage loan options on the market today.

The typical mortgage loan application begins with a credit check and a loan prequalification by one or more lenders with a loan originator acting as the middleman between the loan applicant, the credit companies and the lender. Lenders will require the applicant's credit score, gross monthly income, down payment amount and any source of the down payment, monthly expenses, other loan payments and other significant financial data. If the credit score and financial condition of the applicant is acceptable, the applicant is often prequalified for a maximum loan amount.

Once prequalified, a home loan applicant is then required to obtain an appraisal of the home. At this time, the applicant will typically be required to order the title to the property along with any state-specific stamps or taxes. The applicant may also be requested to provide insurance for the home, including flood insurance, if required by the lender. The loan originator continues to act as the middleman in gathering this documentation.

Prior to final approval of the loan, updated financial information is typically required to verify that the applicant's financial circumstances have not changed since the prequalification and that the source of the income is legitimate. At the end of the process, all required documentation is assembled and stacked in the precise order as specified by the lender and underwriter for final review and loan approval.

Current mortgage systems rely on loan originators to conduct all communication between lenders, third party resources and applicants. Depending on the financial institution or other entity a consumer is interfacing with, an applicant, along with the originator, may interact with multiple people, including underwriters, loan processors and agents. As a result, home loan origination systems are very cumbersome and slow, require experts to guide applicants through the process, and are prone to error and fraud. Furthermore, the interest rate charged on mortgages must be increased to accommodate current inefficient home loan origination systems. More people involved means more salaries to pay.

### SUMMARY OF THE INVENTION

The present invention is a distributed computer apparatus configured to generate at least one stacked loan application object. The apparatus includes at least one applicant interface which includes hardware and software for receiving applicant data to create at least one applicant data object. A SOLO server receives the at least one applicant data object and transforms the data from the applicant data object to create at least one lender vendor request object. The lender vendor request object is relayed to one of a plurality of lender vendor servers. The SOLO server also stores at least one data object which contains data specifying at least one stacked application order.

### DETAILED DESCRIPTION OF INVENTION

For the purpose of promoting an understanding of the present invention, references are made in the text to exemplary embodiments of a self-operated loan originator (SOLO) apparatus, only some of which are described herein. It should be understood that no limitations on the scope of the invention are intended by describing these exemplary embodiments. One of ordinary skill in the art will readily appreciate that alternate but functionally equivalent structures and processes may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

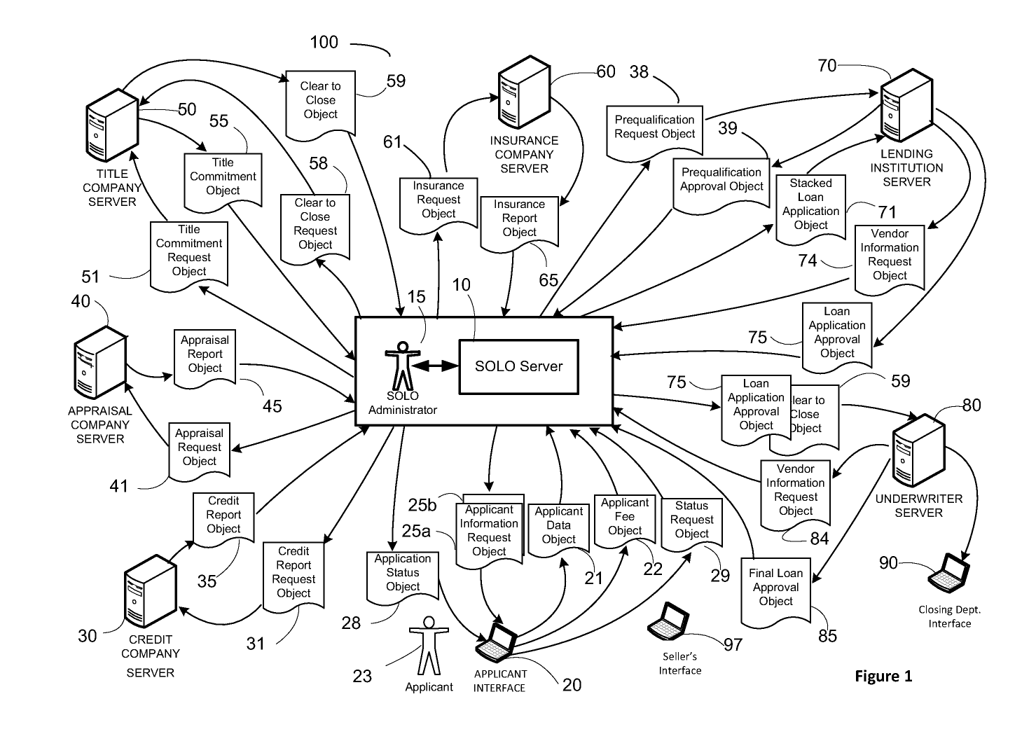

FIG. 1 illustrates an exemplary embodiment of a self-operated loan originator (SOLO) apparatus 100. In the exemplary embodiment shown, SOLO apparatus 100 includes SOLO server 10, which is configured, monitored and maintained by SOLO administrator 15. In further exemplary embodiments, SOLO ver 10 may not be overseen by SOLO administrator 15.

As illustrated in FIG. 1 SOLO server 10 is in communication with a plurality of lender vendor servers, including credit company server 30, appraisal company server 40, title company server 50, insurance company server 60, lending institution server 70 and underwriter server 80. By creating and receiving a plurality of objects, SOLO server 10 is able to communicate with a plurality of lender vendor servers 30, 40, 50, 60, 70 and 80 using lender vendor request objects (for example, 31, 41, 51, 58, 61, 71) to guide applicant 23 through the home loan application process. SOLO server 10 is also configured to receive information from lender vendor servers 30, 40, 50, 60, 70 and 80 in the form of lender vendor information objects (for example, 35, 45, 55, 65, 75, 85).

In further exemplary embodiments, SOLO server 10 may be configured to accept and receive data from more or fewer lender vendor servers. In still further exemplary embodiments, SOLO apparatus 100 may include a plurality of SOLO servers 10, each specifically configured to accept and receive data from a single specific lender vendor server.

Using applicant interface 20, which is configured with software to receive applicant data, applicant 23 initiates the application process by entering applicant data and creating applicant data object 21. In the exemplary embodiment shown, applicant data object 21 includes information about an applicant including, but not limited to, identifying information, personal history, financial data and any other information required by SOLO server 10 to create additional data objects and result in loan approval.

In the exemplary embodiment shown, applicant data object 21 is transmitted to SOLO server 10 along with applicant fee object 22. Applicant 23 may be charged a processing fee, application fee, submission fee or other fee for using and applying for a loan through SOLO apparatus 100. Applicant fee object 22 includes information pertaining to applicant's 23 payment of these fees. For example, applicant fee object 22 may include credit or debit card information, account debit information or other payment data. In other exemplary embodiments, applicant 23 may not be required to submit a payment, or may not be required to submit a payment until a later time. Applicant fee object 22 may therefore be created independently of applicant data object 21 and relayed to SOLO server 10 separate from other objects.

SOLO server 10 then receives applicant data object 21 (and applicant fee object 22, if created and transmitted with applicant data object 21) and process the information attributable to applicant data object 21. SOLO server 10 determines whether applicant 23 included all necessary information for applicant data object 21. If not, SOLO server 10 may create an applicant information request object 25. As illustrated in FIG. 1, SOLO server 10 creates a plurality of information request objects 25a, 25b, each of which include requests for information to applicant 23.

For example, applicant information request object 25a contains a request for additional personal information about applicant 23, while applicant information request object 25b contains a request for application formalities, such as financial data or supporting documentation. Applicant information request objects 25a, 25b may be created by SOLO server 10 in response to any information submitted by applicant 23 or obtained from lender vendor servers 30, 40, 50, 60, 70 and 80 when additional or supporting data is required from applicant 23.

Applicant 23 may generate additional applicant data objects 21 as required to provide SOLO server 10 with all information and documentation required to process a home loan application. As SOLO server 10 receives applicant data, SOLO server 10 accumulates and stores the data to create a stacked ban application object 71 at the end of the application process.

SOLO server 10 may also create application status object 28 in response to applicant data object 21 or status request object 29, which applicant 23 may create at any time using applicant interface 20.

Once SOLO server 10 determines that all required information for completing loan approval steps has been obtained, SOLO server 10 communicates with lender vendor servers 30, 40, 50, 60, 70 and 80 using lender vendor request objects (such as 31, 41, 51, 61) to complete the loan approval process for applicant 23.

As illustrated in FIG. 1, once SOLO server 10 has all information required for a credit report to be obtained for applicant 23, SOLO server 10 creates credit report request object 31 and transmits credit report request object 31 to credit company server 30. In the exemplary embodiment shown, credit company server 30 may correspond to any credit company which may be used to obtain credit report.

After a credit report for applicant 23 is completed, credit company server 30 creates credit report object 35, which includes all the data of applicant's 23 credit report, and transmits credit report object 35 to SOLO server 10. SOLO server 10 stores the data from credit report object 35 and organizes the data to be used in a stacked loan application object 71.

Should additional information be required from applicant 23 in response to credit report object 35, SOLO server 10 may generate an applicant information request object 25. In some exemplary embodiments, SOLO server 10 may be configured to generate an application status object 28 in response to receiving credit report object 35 to alert applicant 23 to the status of his or her application.

In some exemplary embodiments, SOLO server 10 may be configured with software to determine whether an applicant's 23 credit report information alone would preclude applicant 23 from getting a home loan, based on criteria from lending institutions. If applicant's 23 credit reports render applicant 23 immediately ineligible for any loan, SOLO server 10 may create a non-approval object which alerts applicant 23 to his or her non-approval status. In still further exemplary embodiments, SOLO server 10 may provide additional feedback to applicant 23 to advise applicant 23 how to begin rectifying a poor credit report.

If applicant's 23 credit reports do not automatically preclude applicant 23 from proceeding with the loan application process, SOLO server 10 generates prequalification request object 38, which is transmitted to lending institution server 70. In the exemplary embodiment shown, lending institution server 70 may correspond to any lending institution which may be utilized by SOLO apparatus 100. Once the lending institution processes prequalification request object 38, lending institution server 70 generates prequalification approval object 39, which contains data pertaining to whether or not applicant 23 is prequalified for a loan and, if so, for how much. If applicant 23 is not prequalified for a loan, prequalification approval object 39 may include information pertaining to why applicant 23 was not eligible for prequalification.

In further exemplary embodiments, SOLO server 10 may be configured to transmit prequalification approval object 39 to applicant 23 to be displayed using applicant interface 20 to provide applicant 23 with proof of prequalification. In some exemplary embodiments, SOLO server 10 may relay prequalification information to applicant 23 using application status object 28.

After the prequalification steps, SOLO server 10 may then continue with the home loan application process if all required information has been obtained from applicant 23. In other exemplary embodiments, SOLO server 10 may require authorization from applicant 23 or SOLO administrator 15 to continue with the application process.

After prequalification is complete, SOLO server 10 creates lender vendor request objects 41, 51 and 61, which in these exemplary embodiment shown are appraisal request object 41, title request object 51, and insurance request object 61. Lender vendor request objects 41, 51 and 61 may be created simultaneously or in a sequence as information required to generate lender vendor request objects 41, 51 and 61 is obtained.

Lender vendor request objects 41, 51 and 61 are relayed to lender vendor servers 40, 50 and 60, which may be correspond to any lender vendor or lender vendors used by SOLO apparatus 100 to complete home loan application processing.

Appraisal request object 41 is transmitted to appraisal company server 40, which in the exemplary embodiment shown may be any appraisal service or company which may be utilized by SOLO apparatus 100. Once an appraisal is completed, appraisal company server 40 creates appraisal report object 45, which is transmitted to SOLO server 10. SOLO server 10 stores the information from appraisal report object 45 to be used to create stacked loan application object 71.

Similarly, title commitment request object 51 is transmitted to title company server 50, which in the exemplary embodiment shown may be any title service or company which may be utilized by SOLO apparatus 100. Once the title service or company has completed all necessary work and obtained all necessary information, title company server 50 creates title commitment object 55, which is transmitted to SOLO server 10. SOLO server 10 stores the information from title commitment object 55 to be used to create stacked loan application object 71.

Insurance request object 61 transmitted to insurance company server 60, which in the exemplary embodiment may be any insurance company or agent which may be utilized by SOLO apparatus 100. Once the insurance company or agent has obtained the necessary insurance information, insurance company server 60 creates insurance report object 65, which is transmitted to SOLO server 10. SOLO server 10 stores the information from insurance report object 65 to be used to create stacked loan application object 71.

At any point during the time SOLO server 10 is in communication with lender vendor servers 40, 50 and 60, lender vendor companies may require additional information from applicant 23. Lender vendor servers 40, 50 and 60 may be configured with software to create a lender vendor information request object, which may be transmitted to SOLO server 10 and relayed to applicant 23 and displayed on applicant interface 20. Applicant 23 may then have the opportunity to provide additional information as required and create additional applicant data objects 21. Upon receiving application data objects 21, SOLO server 10 processes the information and creates additional lender vendor request objects which are transmitted to the proper lender vendor server.

In the exemplary embodiment described in FIG. 1, lender vendor servers 30, 40, 50 and 60 may belong to any lender vendor which may be used by SOLO apparatus 100. In still further exemplary embodiments, applicant 23 may be able to request specific preferred lender vendors be used. For example, applicant 23 may be able to create lender vendor request objects using applicant interface 20, either as a voluntary action or in response to a prompt from SOLO apparatus 100, which instructs SOLO server 10 to communicate with a specific lender vendor server.

Once SOLO server 10 has compiled all loan information necessary to generate a complete application, SOLO server 10 creates stacked loan application object 71. Stacked ban application object 71 contains all data pertaining to a home ban application which may be a universal selection of information transmitted to all lending institution servers 70 or dictated by specific lending institution servers 70.

Lending institution server 70 receives stacked lean application object 71 and arranges the data for the lending institution to review.

Once the lending institution is able to approve a ban application, lending institution server 70 generates ban application approval object 75, which is transmitted to SOLO server 10. Using the information from ban application approval object 75, SOLO server 10 generates clear to dose request object 58, which is transmitted to title company server 50. The title company then provides its clear to dose, and title company server 50 generates clear to dose object 59, which is transmitted to SOLO server 10. SOLO server 10 stores clear to dose object 59 and generates ban application approval object 75. Clear to dose object 59 is compiled with ban application approval object 75 and transmitted to underwriter server 80 for an underwriter.

Once the underwriter is able to complete underwriting of the application, underwriter server 80 generates final ban approval object 85, which is transmitted to SOLO server 10. SOLO server 10 may then transmit final ban approval object 85 to applicant 23 to be displayed on applicant interface 20, or create a final ban approval status object configured to be displayed on applicant interface 20.

In some exemplary embodiments, SOLO apparatus 100 may include a closing department interface 90, which is configured with software to facilitate communication between a dosing department and an underwriter. Similarly, SOLO apparatus 100 may be configured to receive information from (and display information to) a seller using a seller interface 97.

In some exemplary embodiments, a lender vendor may require additional information from an applicant 23 or SOLO server 10 in order to complete the request contained in lender vendor request objects (31, 41, 51, 58, 61, 71). A lender vendor server (30, 40, 50, 60, 70, 80) may then generate a lender vendor information request object, which is relayed to SOLO server 10. SOLO server 10 may either forward the lender vendor information request object directly to an applicant interface for an applicant to supply the additional information, or SOLO server 10 may process the lender vendor information request object and create an applicant information request object.

When responding to either an applicant information request object or a lender vendor information request object, applicant 23 uses applicant interface 20 to enter information and generate subsequent applicant data objects, which are transformed by SOLO server 10 to create updated lender vendor request objects. Multiple lender vendor information request objects and subsequent applicant data object may be created before a lender vendor determines it has all the information necessary to fulfill a request.

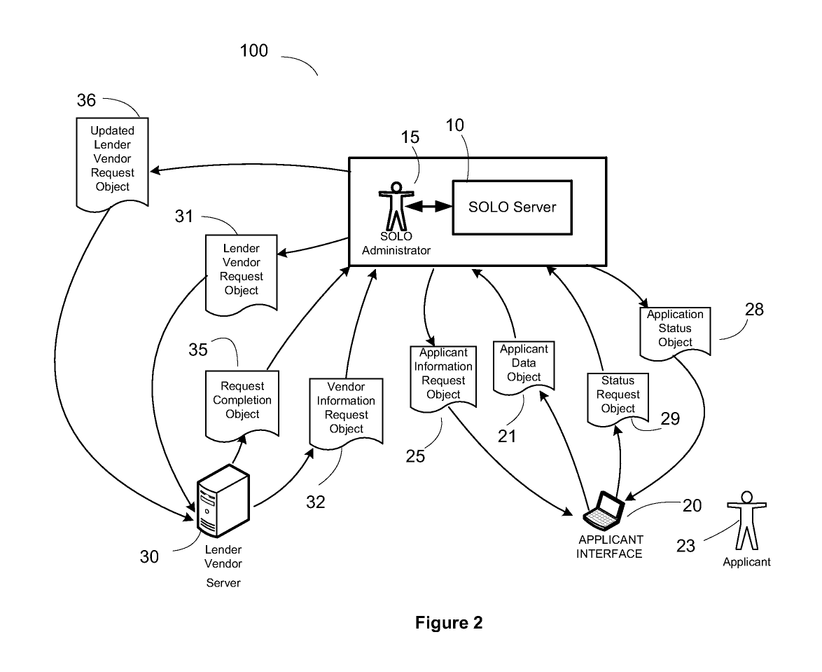

FIG. 2 is an exemplary embodiment of a single lender vendor communication using SOLO apparatus 100. In the exemplary embodiment shown, SOLO server 10 is configured to receive and accept data objects from a lender vendor server 230 and applicant 23 through applicant interface 20. Lender vendor server 230 may belong to any lender vendor utilized by SOLO apparatus 100, including, but not limited to, credit companies, appraisal companies, title companies, insurance companies, lending institutions, underwriters, and financial institutions.

SOLO server 10 generates lender vendor request object 231, which contains information and data pertaining to a specific request for information required by SOLO server 10 to continue the loan application process. For example, lender vendor request object 231 may contain information pertaining to a credit report request, including applicant's 23, name, personal information and financial information necessary for a credit company to complete a credit report. Lender vendor request object 231 is then transmitted to lender vendor server 230.

If the lender vendor determines that it has all information necessary to complete the request, the lender vendor fulfills SOLO server's 10 request. Lender vendor server 230 creates request completion object 235, which contains the data and information requested by SOLO server 10. For example, if the request was for a credit report, request completion object 235 would contain the results of the credit report. SOLO server 10 then stores the information from request completion object 235 to be used to create future lender vendor request objects and, ultimately, a stacked loan application object 71 (not shown).

If the lender vendor determines that additional nformation is required to fulfill the request, lender vendor server 230 creates lender vendor information request object 232, which is transmitted to SOLO server 10. SOLO server 10 processes the request for additional information to determine if applicant 23 has provided that information, either during the creation of an initial applicant data object 21 or subsequent applicant data objects 21. If applicant 23 still needs to supply the requested information, SOLO server 10 generates applicant information request object 25, which is relayed to applicant 23 to be displayed on applicant interface 20.

In some exemplary embodiments, applicant 23 may receive an alert, such as by email, to submit additional information. In further exemplary embodiments, applicant 23, using applicant interface 20, may generate status request object 29. SOLO server 10 may processes status request object 29 and relay applicant information request object 25 or application status object 28 in response. In still further exemplary embodiments, applicant 23 may periodically check applicant interface 20, which is configured to display the request for information contained in applicant information request object 25.

Using applicant interface 20, applicant 23 provides the requested information and creates applicant data object 21, which is relayed to SOLO server 10. SOLO server 10 processes applicant data object 21 and creates updated lender vendor request object 236, which contains information and data responding to the lender vendor's request for additional information.

Updated lender vendor request object 236 is transmitted to lender vendor server 230, and this communication loop repeats until the lender vendor has all information necessary to complete SOLO server's 10 original request and create request completion object 235.

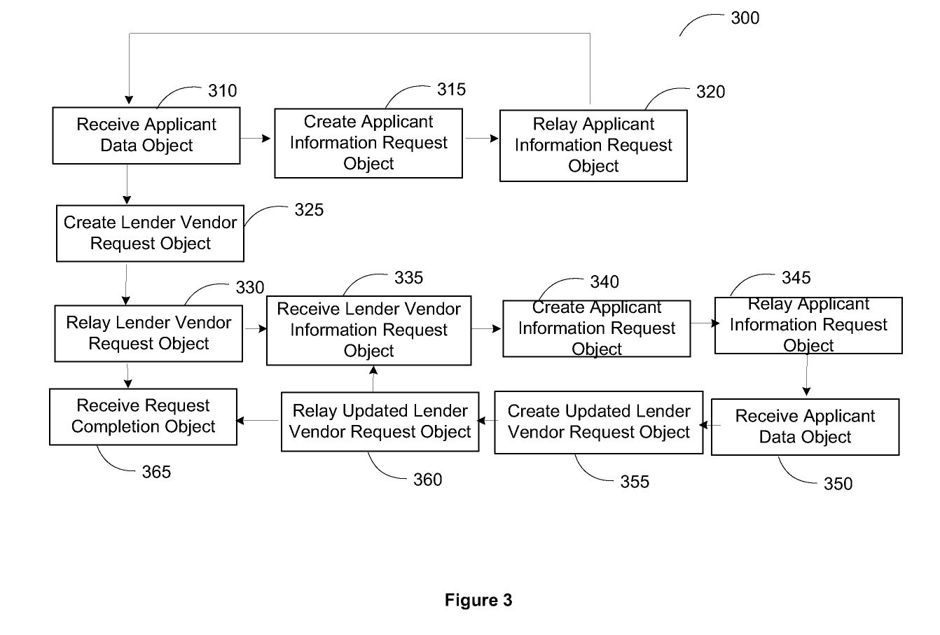

FIG. 3 is a flowchart 300 illustrating an exemplary communication between a SOLO server and a lender vendor server.

In Step 310, the SOLO server receives an applicant data object from an applicant interface. An applicant data object contains information pertaining to an applicant which is required to complete a loan application. For example, an applicant data object may contain an applicant's personal information, financial information and any other information required by a SOLO server.

In some exemplary embodiments, an applicant data object may not contain all the information required by the SOLO server. The SOLO server may then create an applicant information request object (Step 315) and relay the applicant information request object to an application for display on an applicant interface (Step 320).

Steps 310 through 320 are repeated until the SOLO server determines it has all information necessary for further processing. SOLO server then creates a lender vendor request object in Step 325 which contains information pertaining to a request to a specific lender vendor. For example, a lender vendor request object may contain information for a request for a credit report, prequalification approval, appraisal report, title commitment, insurance report, application approval, clear to close assurance, or underwriter's approval. Depending on the type of request, SOLO server transmits the lender vendor request object to the proper lender vendor server (Step 330).

If the lender vendor determines that additional information is required to process the request, the lender vendor server creates a lender vendor information request object, which is received by SOLO server in Step 335. A lender vendor information request object contains data pertaining to a request for additional applicant information which is required by a lender vendor. The SOLO server then creates an applicant information request object (Step 340) which is relayed to the applicant (Step 345) to be displayed on an applicant interface.

Applicant's response to the request is received by the SOLO server as an applicant data object in Step 350, SOLO server then creates an updated lender vendor request object (Step 355), which is relayed to the lender vendor server (Step 360). The updated lender vendor request object contains information pertaining to the original request, as well as the updated or supplemental information requested by the lender vendor.

Steps 335 through 360 are repeated until the lender vendor determines it has all the necessary information to complete the request. The SOLO server then receives a request completion object in Step 365. A request completion object contains the information and data requested by the SOLO server in the lender vendor request object. For example, when requesting a credit report, the request completion object will contain the information which is part of a credit report, such as the applicant's credit score(s).

While in the exemplary embodiment shown, the SOLO server is communicating with a single lender vendor server, in further exemplary embodiments, the SOLO server may communicate with multiple lender vendor servers separately or simultaneously.

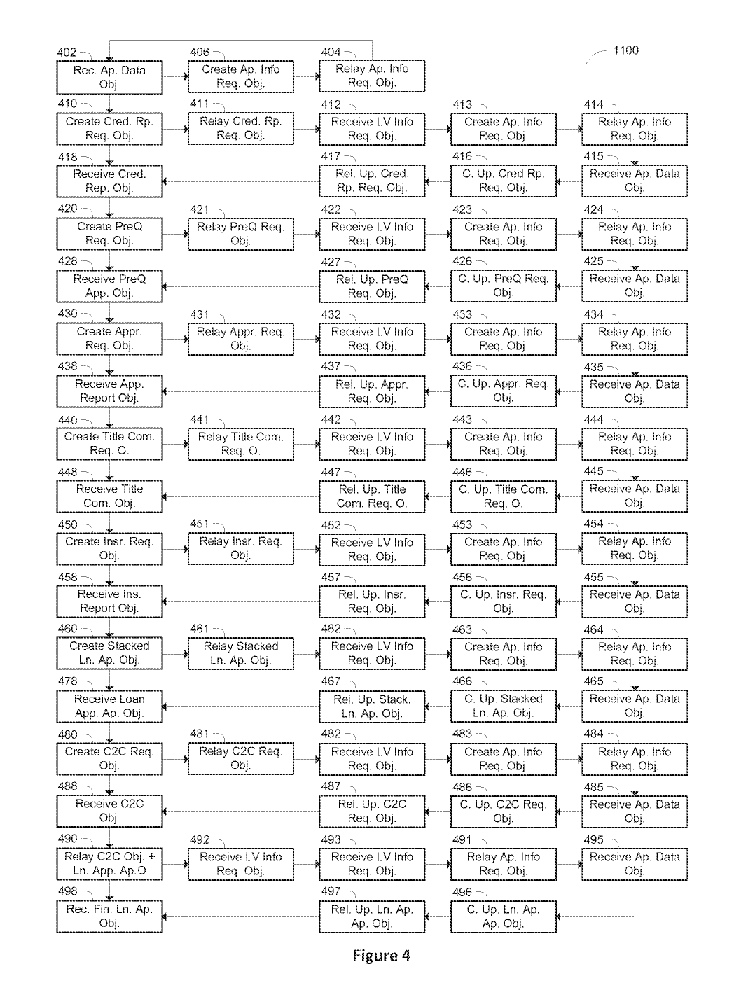

FIG. 4 is a flowchart 400 illustrating exemplary steps for completing a loan application process using SOLO server.

In step 402, the SOLO server receives an applicant data object containing information about an application, including, but not limited to, personal and financial data. An applicant data object is creating by an applicant using an applicant interface.

In some exemplary embodiments, SOLO server may also receive an applicant fee object (Step 404), which contains information pertaining to applicant's payment of any fees required to use the SOLO server or begin the loan application process. In further exemplary embodiments, SOLO server may receive an applicant fee object at any time during the application process.

In Step 406, SOLO server creates an applicant information request object to be displayed using an applicant interface. An applicant information request object contains information pertaining to a request for an applicant to provide additional or updated information, such as, for example, if an applicant initially provides incomplete or inconsistent information. A SOLO server may create applicant information request objects at any time during the application process, whether in response to a lender vendor's request for additional information or not.

The applicant information request object is relayed to an applicant interface (Step 408) for the applicant to provide additional information in the form of an applicant data object. Steps 402 through 408 are repeated until the SOLO server determines that it has received all required information.

Using the information from the applicant data object(s), the SOLO server creates a credit report request object (Step 410). In Step 411, the credit report request object is transmitted to a credit company server. In the exemplary embodiment described, the credit report request object contains all the information necessary for a credit company to conduct a credit report. If the credit company determines any information is missing or incomplete, the credit company will generate a lender vendor information request object, which is received by the SOLO server (Step 412).

In some exemplary embodiments, the lender vendor information request object may be relayed directly to an applicant interface. In other exemplary embodiments, as illustrated in FIG. 400, the SOLO server processes the lender vendor information request object to create an applicant information request object (Step 413), which is relayed to an applicant interface in Step 414.

In response, the SOLO server receives and applicant data object (Step 415), which contains the information and data requested by the credit company server. In Step 416, the SOLO server uses the information from the applicant data object to create an updated lender vendor request object, or updated credit report request object, and relays the updated object to the credit company server in Step 417.

Steps 412 through 417 are repeated until the credit company receives all the information required to complete a credit report. Once the credit company generates a credit report it sends that information to the SOLO server in the form of a credit report object. The SOLO server receives the credit report object (Step 418) and stores the data to be used to generate further lender vendor request objects.

Once the SOLO server receives and processes the credit report object, the SOLO server generates a prequalification request object (Step 420). In Step 421, the prequalification request object is transmitted to a lending institution server. The credit report object contains information about the applicant that the lending institution will require to prequalify the applicant.

In some instances, the lending institution will require additional information. A request for that additional information is received by the SOLO server as a lender vendor information request object in Step 422. In some exemplary embodiments, the lender vendor information request object may be relayed directly to an applicant interface. In further exemplary embodiments, as illustrated in FIG. 4, the SOLO server will process the lender vendor information request object and create an applicant information request object (Step 423) which is relayed to the applicant through an applicant interface (Step 424).

Applicant provides the additional information in the form of an applicant data object, which is received by the SOLO server in Step 425. The SOLO server then creates an updated prequalification request object (Step 426), which is relayed to the lending institution server in Step 427.

Steps 422 through 427 may be repeated until the lending institution has all the information necessary to respond to the prequalification request. The lending institution generates a prequalification approval object, which is received by the SOLO server (Step 428). The prequalification approval object will contain information pertaining to whether or not an applicant was able to be prequalified, and, if not, any reasons for the denial.

In the exemplary embodiment described, the SOLO server automatically generated the prequalification request object and sent it to a lending institution. In further exemplary embodiments, an applicant may need to authorize the SOLO server to generate a prequalification request object. In still further exemplary embodiments, an applicant may also, voluntarily or as a requirement, direct the SOLO server to relay the prequalification request object to a particular lending institution.

Assuming the applicant was successfully prequalified for a loan, the SOLO server generates a plurality of lender vendor request objects.

First, in Step 430, the SOLO server creates an appraisal request object, which is transmitted to an appraisal company server in Step 431. In the exemplary embodiment described, the appraisal request object contains information and data required for an appraisal company to perform an appraisal and generate an appraisal report.

If the appraisal company requires additional information, it requests that information in the form of a lender vendor information request object, which is received by the SOLO server in Step 432. In some exemplary embodiments, the SOLO server may relay the lender vendor information request object directly to an applicant interface for an applicant to respond. However, as described in FIG. 4, the SOLO server may also process the lender vendor information request object to create an applicant information request object (Step 433), which is relayed to an applicant interface (Step 434).

Using an applicant interface, an applicant responds to the request for additional information by creating an applicant data object, which is relayed to the SOLO server in Step 435. The SOLO server processes the applicant data object and uses the information to create an updated lender vendor request object, or update appraisal request object (Step 436). The updated appraisal request object is relayed to the appraisal company server in Step 437.

Steps 432 through 437 may be repeated until the appraisal company has all the information necessary to complete an appraisal report. Once the report is completed, all of the information and data pertaining to the report is received by the SOLO server as an appraisal report object (Step 438). The SOLO server saves the information and data contained in the appraisal report object to create further lender vendor request objects.

The SOLO server also generates a title commitment request object (Step 440). The title commitment request object is relayed to a title company server in step 441. In the exemplary embodiment described, the title commitment request object contains information and data required by a title company to generate a title commitment.

If the title company requires additional information, it requests that information in the form of a lender vendor information request object, which is received by the SOLO server in Step 442. In some exemplary embodiments, the SOLO server may relay the lender vendor information request object directly to an applicant interface for an applicant to respond. However, as described in FIG. 4, the SOLO server may also process the lender vendor information request object to create an applicant information request object (Step 443), which is relayed to an applicant interface (Step 444).

Using an applicant interface, an applicant responds to the request for additional information by creating an applicant data object, which is relayed to the SOLO server in Step 445. The SOLO server processes the applicant data object and uses the information to create an updated lender vendor request object, or update title commitment request object (Step 446). The updated title commitment request object is relayed to the title company server in Step 447.

Steps 442 through 447 may be repeated until the title company has all the information necessary to complete a title commitment. Once the commitment is secured, all of the information and data pertaining to the commitment is received by the SOLO server as a title commitment object (Step 448). The SOLO server saves the information and data contained in the title commitment object to create further lender vendor request objects.

The SOLO server also generates an insurance request object (Step 450). The insurance request object is relayed to an insurance company server in step 451. In the exemplary embodiment described, the insurance request object contains information and data required by an insurance company to generate an insurance report.

If the insurance company requires additional information, it requests that information in the form of a lender vendor information request object, which is received by the SOLO server in Step 452. In some exemplary embodiments, the SOLO server may relay the lender vendor information request object directly to an applicant interface for an applicant to respond. However, as described in FIG. 4, the SOLO server may also process the lender vendor information request object to create an applicant information request object (Step 453), which is relayed to an applicant interface (Step 454).

Using an applicant interface, an applicant responds to the request for additional information by creating an applicant data object, which is relayed to the SOLO server in Step 455. The SOLO server processes the applicant data object and uses the information to create an updated lender vendor request object, or update insurance request object (Step 456). The updated insurance request object is relayed to the insurance company server in Step 457.

Steps 452 through 457 may be repeated until the insurance company has all the information necessary to complete an insurance report. Once the insurance report is completed, all of the information and data pertaining to the insurance report is received by the SOLO server as an insurance report object (Step 458). The SOLO server saves the information and data contained in the insurance report object to create further lender vendor request objects.

In the exemplary embodiment described, the SOLO server generates the appraisal request object, title request object and insurance request object in a specified order. However, in further exemplary embodiments, these objects may be created and relayed to the respective lender vendor servers in a different order or simultaneously. SOLO server may therefore communicate with multiple lender vendor servers at the same time.

In still further exemplary embodiments, the SOLO server may send and receive additional communications to and from an applicant interface. For example, in some exemplary embodiments, a SOLO server may not generate a further lender vendor request object until an applicant authorizes it to do so, such as with an applicant authorization object. In other exemplary embodiments, a SOLO server may receive applicant preference objects, which are created by an applicant using an applicant interface to designate a specific lender vendor.

In yet further exemplary embodiments, prior to receiving and accepting final object from a lender vendor (i.e., a credit report object, appraisal report object or title request object), the SOLO server may provide an acceptance request object to an applicant requesting the applicant to approve final acceptance of a report or title commitment.

After the SOLO server has received an appraisal report object, title commitment object and insurance report object, the SOLO server compiles of the information and data from every applicant data object, the credit report object, the prequalification object, the appraisal report object, the title commitment object and the insurance report object into a stacked loan application object (Step 460). In Step 461, the stacked loan application object is transmitted to a lending institution server.

If the lending institution requires additional information, it requests that information in the form of a lender vendor information request object, which is received by the SOLO server in Step 462. In some exemplary embodiments, the SOLO server may relay the lender vendor information request object directly to an applicant interface for an applicant to respond. However, as described in FIG. 4, the SOLO server may also process the lender vendor information request object to create an applicant information request object (Step 463), which is relayed to an applicant interface (Step 464).

Using an applicant interface, an applicant responds to the request for additional information by creating an applicant data object, which is relayed to the SOLO server in Step 465. The SOLO server processes the applicant data object and uses the information to create an updated lender vendor request object, or updated stacked loan application object (Step 466). The updated stacked loan application object is relayed to the lending institution server in Step 467.

Steps 462 through 467 may be repeated until the lending institution has all the information necessary to approve a loan application. Once the loan application is approved, a loan application approval object is received by the SOLO server (Step 478).

In Step 480, the SOLO server generates a clear to close request object, which is relayed to a title company server in Step 481. The clear to close request object contains all of the information and data a title company requires to clear a real estate transaction for closing.

At this point, no further information should be required from the applicant. However, if additional information is required, the title company requests that information in the form of a lender vendor information request object, which is received by the SOLO server in Step 482. In some exemplary embodiments, the SOLO server may relay the lender vendor information request object directly to an applicant interface for an applicant to respond. However, as described in FIG. 4, the SOLO server may also process the lender vendor information request object to create an applicant information request object (Step 483), which is relayed to an applicant interface (Step 484).

Using an applicant interface, an applicant responds to the request for additional information by creating an applicant data object, which is relayed to the SOLO server in Step 485. The SOLO server processes the applicant data object and uses the information to create an updated lender vendor request object, or updated clear to close request object (Step 486). The updated clear to close request object is relayed to the title company server in Step 487.

Steps 482 through 487 may be repeated until the title company has all the information necessary to clear the transaction for closing. Once the transaction is cleared for dosing, a clear to dose object is received by the SOLO server (Step 488).

In Step 490, the clear to close object, along with the loan application approval object, are relayed to an underwriter server. The underwriter should not require any additional information. However, if additional information is required, the underwriter requests that information in the form of a lender vendor information request object, which is received by the SOLO server in Step 492.

In some exemplary embodiments, the SOLO server may relay the lender vendor information request object directly to an applicant interface for an applicant to respond. However, as described in FIG. 4, the SOLO server may also process the lender vendor information request object to create an applicant information request object (Step 493), which is relayed to an applicant interface (Step 494).

Using an applicant interface, an applicant responds to the request for additional information by creating an applicant data object, which is relayed to the SOLO server in Step 495. The SOLO server processes the applicant data object and uses the information to create an updated lender vendor request object, or updated loan application approval object (Step 496). The updated loan application approval object is relayed to the underwriter server in Step 497.

Steps 492 through 497 may be repeated until the underwriter has all the information necessary to underwrite a ban application. Once the underwriter has all the information, the underwriter is able to underwrite the ban application, and a final ban approval object is received by the SOLO server (Step 498), and the loan application process is complete.

In some exemplary embodiments, and applicant may be able to request the status of the loan application at any time during the application process. When an applicant requests the status of his or her application, the SOLO server will receive an application status request object.

The SOLO server will then create an application status object, which is relayed to an applicant interface. The application status object contains information and data pertaining to the status of an applicant's application, including, but not limited to, any missing or incomplete information, the current location of the application in the application process, the steps of the application process completed, future steps in the application process remaining, current lender vendors being used for the application, any preferences submitted by the applicant, and any other information which may be desired by the applicant in learning about the status of a loan application.

What is claimed is:

1. A distributed computer apparatus configured to generate at least one stacked loan application object comprised of:
at least one applicant interface comprised of computer hardware configured with software for receiving applicant data to create at least one applicant data object;
at least one SOLO server which receives said at least one applicant data object and transforms data from said at least one applicant data object to create at least one lender vendor request object which is transmitted to at least one lender vendor server;
wherein said SOLO server is configured to store at least one data object which contains data specifying at least one stacked application order.

2. The apparatus of claim 1 wherein said at least one lender vendor server is a credit company server configured to receive a credit report request object.

3. The apparatus of claim 1 wherein said at least one lender vendor server is an appraisal company server configured to receive an appraisal request object.

4. The apparatus of claim 1 wherein said at least one lender vendor server is a title company server configured to receive a title commitment request object.

5. The apparatus of claim 1 wherein said at least one lender vendor server is at company server configured to receive a clear to close request object.

6. The apparatus of claim 1 wherein said at least one lender vendor server is an insurance company server configured to receive an insurance request object.

7. The apparatus of claim 1 wherein said at least one lender vendor server is a lending institution server configured to receive a prequalification request object.

8. The apparatus of claim 1 wherein said at least one lender vendor server is a lending institution server configured to receive said at least one stacked loan application object.

9. The apparatus of claim 1 wherein said at least one lender vendor server is an underwriter server configured to receive a loan application approval object and a clear to close object.

10. The apparatus of claim 1 wherein said at least one lender vendor request object is an object selected from the group consisting of a credit report request object, an appraisal request object, a title commitment request object, a clear to close request object, an insurance request object, a prequalification request object, a stacked loan application object, and combinations thereof.

11. The apparatus of claim 1 wherein said at least one SOLO server is configured with software to receive said at least one lender vendor request object.

12. The apparatus of claim 1 wherein said at least one SOLO server is configured with software to create at least one applicant information request object.

13. The apparatus of claim 1 wherein said at least one SOLO server is configured with software to store and transform data from a plurality of request completion objects to create said at least one stacked loan application object.

14. A method for creating a stacked loan application object comprising the steps of:
receiving at least one applicant data object;
creating a lender vendor request object;
relaying said lender vendor request object to at least one lender vendor server;
receiving at least one request completion object;
transforming data from said at least one applicant data object and said at least one request completion object;
creating a stacked loan application object.

15. The method of claim 14 wherein said at least one lender vendor server is selected from the group consisting of a credit company server, an appraisal company server, a title company sere insurance company server, a lending institution server, an underwriter server and combinations thereof.

16. The method of claim 14 which further includes the step of receiving at least one lender vendor information request object.

17. The method of claim 16 which further includes the step of creating at least one applicant information request object.

18. The method of claim 17 which further includes the step of relaying said at least one applicant information request object to an applicant interface.

19. The method of claim 18 which further includes the step of creating an updated lender vendor request object.

20. The method of claim 19 which further includes the step of relaying said updated lender vendor request object to said at least one lender vendor server.
